(19) United States
(12) Patent Application Publication
(10) Pub. No.: US 2021/0094066 A1
(43) Pub. Date: Apr. 1, 2021

(54) COATING APPARATUS

(71) Applicant: STC Chemistry, LLC, Dawson, NE (US)

(72) Inventor: Rodney Heinen, Dawson, MO (US)

(73) Assignee: STC Chemistry, LLC, Dawson, NE (US)

(21) Appl. No.: 16/590,100

(22) Filed: Oct. 1, 2019

(51) Int. Cl. B05D 1/02; B05C 5/02; B05C 11/02

(52) U.S. Cl. CPC B05D 1/02; B05C 11/02; B05C 5/0225; B05C 5/0208

(57) ABSTRACT

Coating apparatus (20) includes a pair of juxtaposed, cylindrical bodies (22, 24) defining a nip region (30) therebetween, with each presenting a periphery (26, 28) and being rotatable in opposite directions, respectively. The peripheries (26, 28) of the bodies (22, 24) are provided with a series of laterally extending notches (32), optionally oriented to provide chevron patterns (68) with apices (32a) and diverging legs (70a, 70b); the patterns (68) are positioned so that the apices (32a) first pass through the nip region (30), with the legs (70a, 70b) in trailing relationship. Liquid coating material is directed onto the bodies (22, 24) through an outlet (100, 110) during rotation of the bodies (22, 24). This generates an adjustable spray or fog flow pattern (108) from the apparatus (20) for effective coating of a substrate.

### BACKGROUND OF THE INVENTION

### Field of the Invention

The present invention is broadly concerned with coating apparatus for various substrates and which can be used in a variety of different coating environments. More particularly, this is concerned with particular apparatus as well as methods of coating substrates making use of juxtaposed, peripherally notched cylindrical bodies cooperatively defining a nip region. Liquid coating material is directed towards the nip region during counter-rotation of the bodies, which creates an even and adjustable flow pattern of coating material to facilitate coating operations.

### Description of the Prior Art

Coating devices for particulate substrates, and especially agricultural seeds, have been available for many years. These devices are designed to coat substrates with a variety of agents, such as fungicides, insecticides, pesticides, germination controllers, or fertilizers in liquid polymeric form. Typically, these coaters include a rotating head or similar expedient for creating a spray or fog of coating material. In many cases, the coating material is ejected through a restricted orifice nozzle in order to give a desired coating pattern.

However, these prior devices are plagued by a number of intractable problems. For example, it is very difficult to uniformly coat the particulate material, owing to the fact that many coaters do not generate truly uniform flow patterns. Furthermore, restricted orifice nozzles often become partially or completely clogged, which exacerbates the problem of providing uniform coating characteristics and also can result in a complete shutdown of a coating operation.

There is accordingly a need in the art for improved coating apparatus which avoid the use of highly restricted nozzles typical of the prior art, while creating even, predictable flow patterns serving to evenly coat substrates.

### SUMMARY OF THE INVENTION

The problems outlined above are overcome by the improved coating apparatus of the present invention. Generally speaking, such apparatus comprises a pair of cylindrical, juxtaposed bodies each presenting a peripheral surface and oriented to cooperatively define a nip region between the peripheral surfaces, where each of the peripheral surfaces equipped with a series of laterally spaced apart notches; optionally, the notches define a chevron pattern with an apex and a pair of diverging legs extending from the apex. Preferably, the plates are notched to provide a plurality of circumferentially spaced apart chevron patterns. The overall coater also has apparatus for rotating the bodies in opposite rotational directions, respectively. Structure is provided for delivery of a coating liquid towards the juxtaposed bodies for passage through the nip region from one side of the bodies during rotation thereof, such that the coating liquid is ejected from the nip region after passage therethrough in a direction away from the bodies. Where the bodies are equipped with chevron-defining notches, the bodies are rotated so that the apices thereof pass through the nip region, followed by the diverging legs.

In an embodiment, the bodies are made up of a plurality of individual plates secured together in a face-to-face relationship to present the peripheral surfaces, with each of the plates having a notch formed in the periphery thereof. In order to allow adjustability of the individual plates, the latter are equipped with a plurality of arcuate adjustment slots therethrough, with a series of connection bolts extending through the adjustment slots of each of the plates, so that the relative rotational positions of the individual plates may be adjusted.

The body-rotating apparatus may be in the form of a motor (e.g., a variable speed motor) operatively secured to the one of the juxtaposed bodies, with the other body being in frictional engagement with the driven body so that rotation of the latter effects counter-rotation of the other body.

The invention also provides a method of applying a liquid coating material onto a substrate, comprising the steps of first directing a stream of the liquid coating material generally towards the substrate, and passing the coating material into and through a nip region defined by a pair of cylindrical, juxtaposed bodies each presenting a peripheral surface. The cylindrical bodies are rotated in opposite directions during the liquid application step. In order to provide optimum coating characteristics, the peripheries of the cylindrical bodies are equipped with a series of laterally spaced apart notches, preferably defining a plurality of circumferentially spaced apart chevron patterns, each with an apex and a pair of diverging legs extending from the apex. This causes the bodies, and especially the chevron patterns in the peripheries thereof, to expel the liquid coating material from the nip region and onto the substrate. The spray pattern advantageously diverges from the nip region to create a spray or fog of liquid coating material.

### BRIEF DESCRIPTION OF THE DRAWINGS

FIG. 1 is a perspective view of coating apparatus in accordance with the invention, illustrated in a use position located above an auger conveyor;

FIG. 2 is a rear perspective view of the coating apparatus;

FIG. 3 is a plan view of the coating apparatus;

FIG. 4 is a front elevation view of the coating apparatus;

FIG. 5 is a side view of the coating apparatus;

FIG. 6 is a schematic view illustrating the rotation of the plates forming a part of the rotatable bodies of the coating apparatus, and illustrating the configuration of the peripheral notches in the bodies;

FIG. 7 is a perspective view of one of the rotatable bodies of the coating apparatus, shown with a series of chevron patterns having particular included angles;

FIG. 8 is a perspective view similar to that of FIG. 7, but depicting the rotatable bodies with chevron patterns having different included angles as compared with FIG. 7;

FIG. 9 is an exploded perspective view of one of the rotatable bodies; and

FIG. 10 is a schematic illustration of a series of plate notches forming a chevron pattern with an apex notch and a plurality of diverging notches defining respective chevron legs.

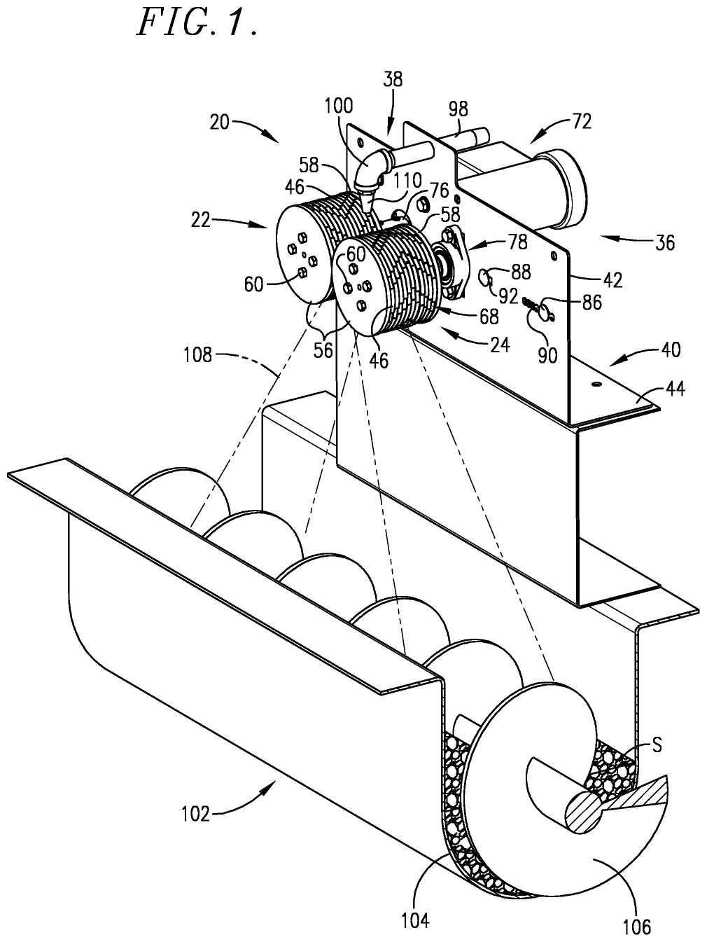

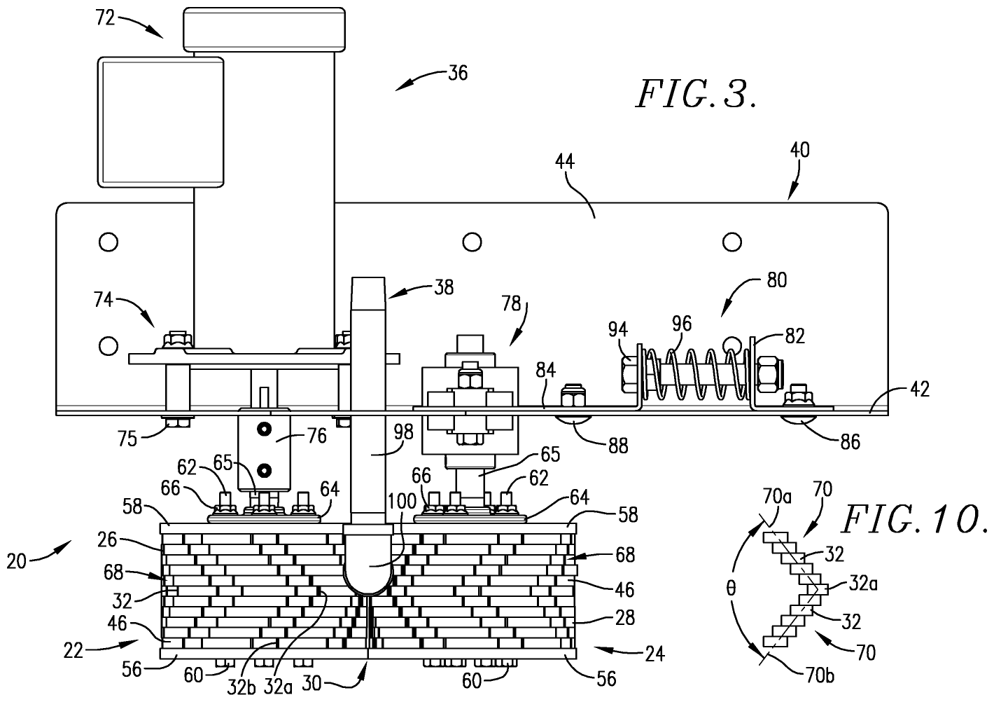

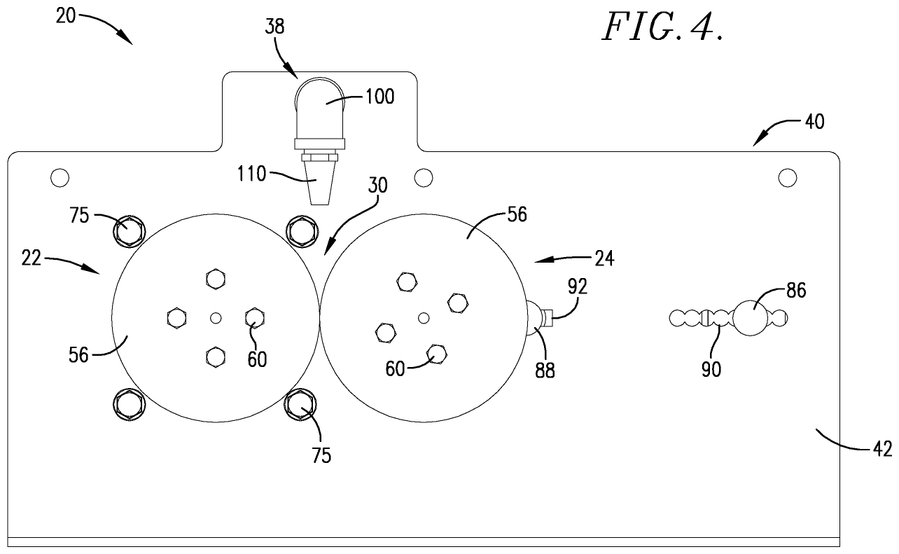

While the drawings do not necessarily provide exact dimensions or tolerances for the illustrated components or structures, FIGS. 1-9 are to scale with respect to the relationships between the components of the structures illustrated therein.

### DETAILED DESCRIPTION OF THE PREFERRED EMBODIMENT

Turning now to the drawings, a coating apparatus 20 in accordance with the invention broadly includes a pair of cylindrical, juxtaposed rollers or bodies 22 and 24 each presenting a peripheral surface 26 and 28 and cooperatively defining a nip region 30 between the bodies. The peripheral surfaces 26, 28 have a series of laterally spaced apart indentations or inclined notches 32 therein, which are important for reasons to be explained. In addition, the overall apparatus 20 includes drive apparatus 36 serving to rotate the bodies 22, 24 in opposite rotational directions, respectively, as well as coating liquid delivery structure 38 positioned adjacent the bodies 22, 24.

In more detail, the apparatus 20 is supported on a generally L-shaped plate 40 having an upstanding wall 42 and a base 44. The body 22 is made up of a series of identical, face-to-face engaged individual plates 46. Each plate 46 has a plurality (here 8) of the circumferentially spaced apart notches 32 formed on the periphery thereof; each notch 32 has an inwardly extending wall 48 presenting a bottom edge 50, as well as an inclined wall 52 extending from the bottom edge 50 toward the periphery of the plate 46. Referring to FIG. 9, it will also be seen that each plate 46 has a series of arcuate adjustment through-slots 54 inboard of the plate periphery.

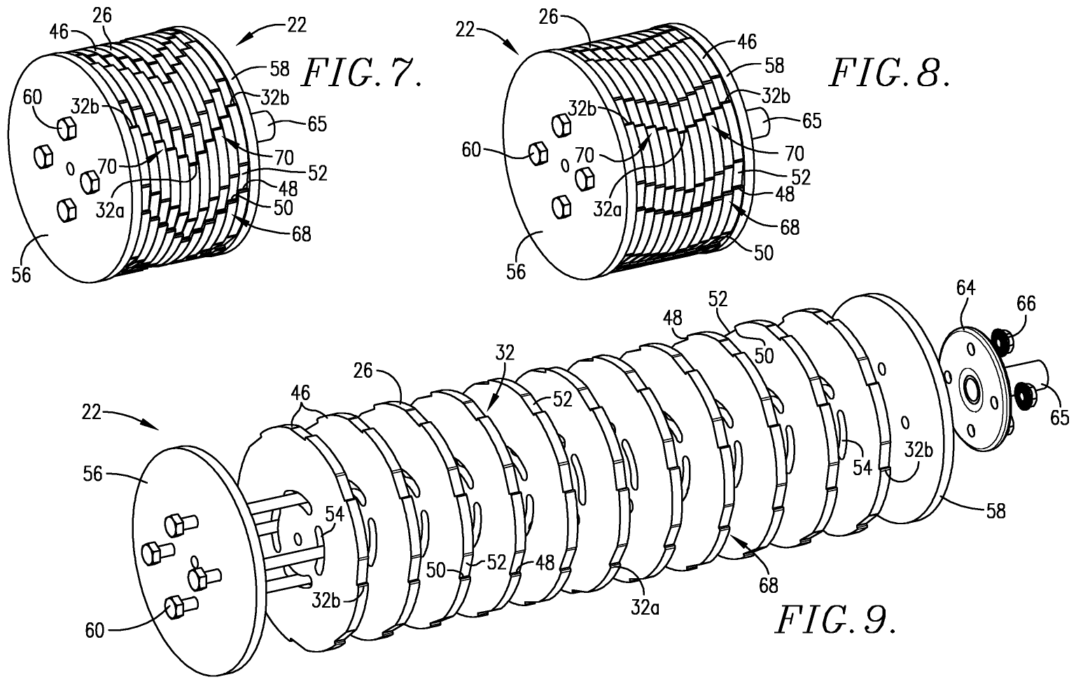

The individual plates 46 are secured together by means of a pair of endmost, smooth, unnotched drive plates 56 and 58, which have a slightly greater diameter than the plates 46. The drive plates have a series of apertures therethrough which receive elongated connection bolts 60. As illustrated, the bolts 60 extend through the adjustment slots 54 of the plates 46 and have threaded inner ends 62. The ends 62 extend through a circular drive shaft mount 64 having a rearwardly extending rotatable drive shaft 65; connection nuts 66 are used to interconnect the mount 64, drive plate 58, the several plates 46, and outer drive plate 56. As assembled, the individual plates 46 are located so that the notches 32 thereof define a series of circumferentially spaced apart chevron patterns 68, including an apex notch 32a and a staggered series of notches 32b which define diverging legs 70 extending outwardly and rearwardly from the apex notch 32a. Furthermore, the patterns 68 are arranged to that during rotation of the bodies 22, 24, the apex notches 32a are shifted toward and through the nip region 30, while the diverging legs 70 trail the apex notches 32a (see FIGS. 7-8 and 10).

Drive apparatus 36 comprises a variable speed motor assembly 72 supported on wall 42 by stand-off connection structure 74 and sleeve-covered through-bolts 75. As illustrated, the motor assembly 72 has a coupler 76 extending through wall 42 and operatively secured to the drive shaft 65 of mount 64 for rotation of the body 22.

The body 24 and mount 64 are identical with those of body 22 and thus like parts have been identically numbered. However, the drive shaft 65 of the body 24 is supported by means of a conventional bearing assembly 78 affixed to wall 42 in spaced relationship to the motor assembly 72. The bodies 22 and 24 are drivingly interconnected by means of the engaged drive plates 56 and 58 on the respective bodies. Thus, when body 22 is rotated through the medium of motor assembly 72, the body 24 is rotated in the opposite rotational direction owing to the frictional engagement between the plates 56 and 58 on each body 22, 24.

An adjustable tensioning device 80 is secured to the face of wall 42 remote from the bodies 22, 24, and includes a pair of spaced apart, apertured, L-shaped brackets 82 and 84 adjustably mounted on wall 42 by means of connectors 86 and 88; connector 86 passes through an elongated, stepped bore 90, whereas connector 88 passes through a shorter, straight slot 92. As depicted, the bracket 84 is also secured to the bearing assembly 78 supporting body 24. A bolt 94 extends through the brackets 82 and 84 and is equipped with a surrounding helical compression spring 96. Adjustment of the position of the bracket 82 is achieved by moving the connector 86 to one of the stepped positions of bore 90, which in turn increases or decreases the force exerted by spring 96 against bracket 84, which is slidable within straight slot 92. This correspondingly increases or decreases the engagement forces between the end plates 56, 58 as needed to assure an appropriate driving connection between the bodies 22 and 24.

The liquid delivery structure 36 includes an elongated pipe 98 equipped with an outlet 100 in the form of an elbow positioned generally above the bodies 22 and 24, and nip region 30. A supply conduit (not shown) is affixed to the end of pipe 98 for delivery of liquid coating material into pipe 98 for ultimate delivery through outlet 100.

### Operation

The coating apparatus 20 can be used in a variety of contexts for coating of substrates, such as fertilizers, sands, seeds, or any other particulate material. In one exemplary use illustrated in FIG. 1, the apparatus 20 is positioned above an auger conveyor 102 including an arcuate housing 104 and a conventional auger 106 within housing 104 and serving to convey a particulate substrate S along the length of the housing beneath the assembly 20.

Generally speaking, the operation of apparatus 20 involves rotation of the bodies 22, 24 by activation of drive apparatus 36 in order to rotate the bodies 22, 24 in opposite rotational directions, respectively; the rotational speeds can vary widely, e.g., from about 40-800 rpm, more preferably from about 150-400 rpm. As depicted, the body 22 would rotate in a clockwise direction, whereas body 24 would be rotated counter-clockwise. During such rotation, liquid coating material is delivered through pipe 98 and outlet elbow 100 generally into the nip region 30. As the bodies 22, 24 rotate, liquid coating material is successively picked up by the notches 32 forming the chevron patterns 68 as the notches pass into the nip region 30. After such passage, the liquid-filled notches 32 expel the coating material downwardly and outwardly, creating a diverging flow pattern 108 (see FIGS. 1 and 5).

The desired flow pattern can be adjusted with great accuracy by appropriate modifications of the rotational speed of the bodies 22, 24 and/or the volume of liquid coating material from outlet 100, and/or the chevron patterns 68 of the bodies 22, 24. In practice, it has been found that these modifications will result in virtually no “backsplash” of coating material upwardly or laterally, thus minimizing any tendency to foul the apparatus 20. However, if, desired, a covering shroud (not shown) may be installed above the bodies 22, 24 with a through-aperture permitting passage of the liquid coating material from the outlet 100 onto the rotating bodies 22, 24.

The coating apparatus 20 illustrated herein is susceptible to a number of modifications and alterations, without departing from the spirit and scope of the invention. For example, the number of plates 46 can be varied as needed in order to achieve the desired spray or fog pattern required for a particular coating application. In like manner, the orientations of the chevron patterns 68 may be changed by appropriate relative positioning of the plates 46. As illustrated in FIG. 10, the center lines 70a and 70b of the diverging legs 70 define an included angle θ. This included angle can vary through a wide range, e.g., from about 20-70°.

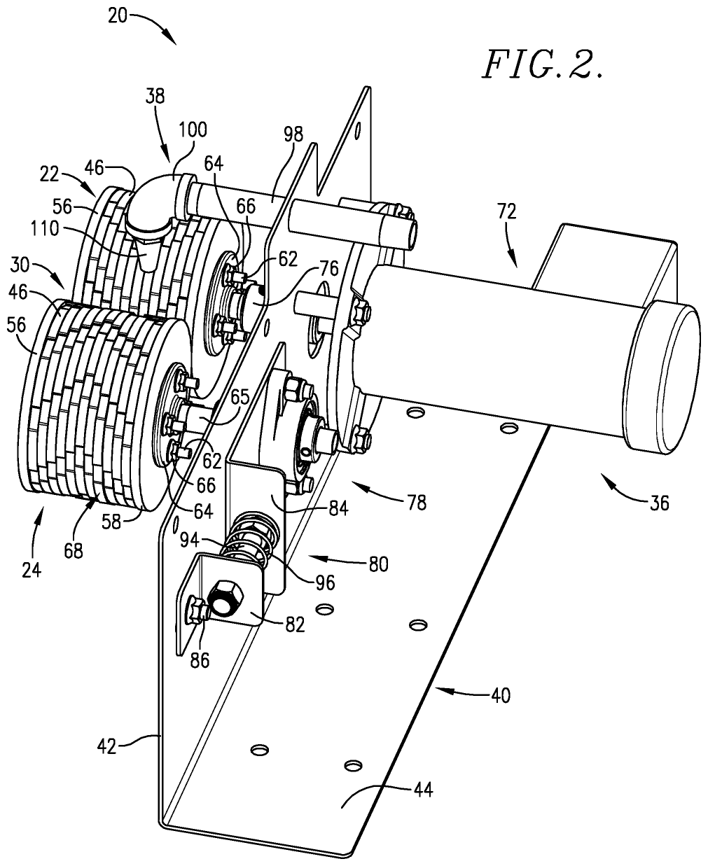

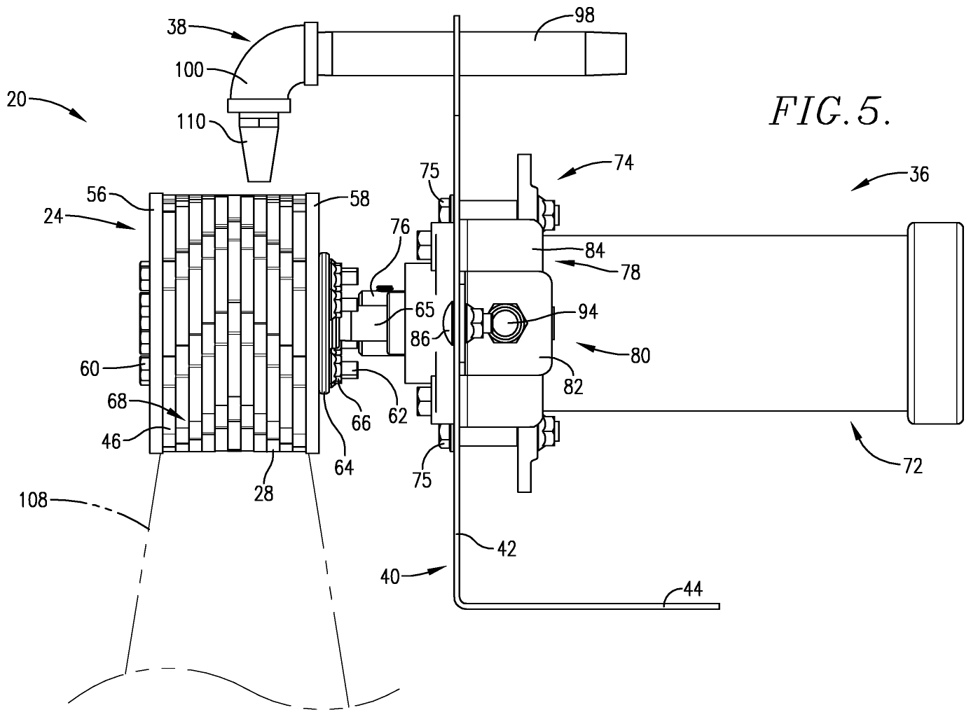

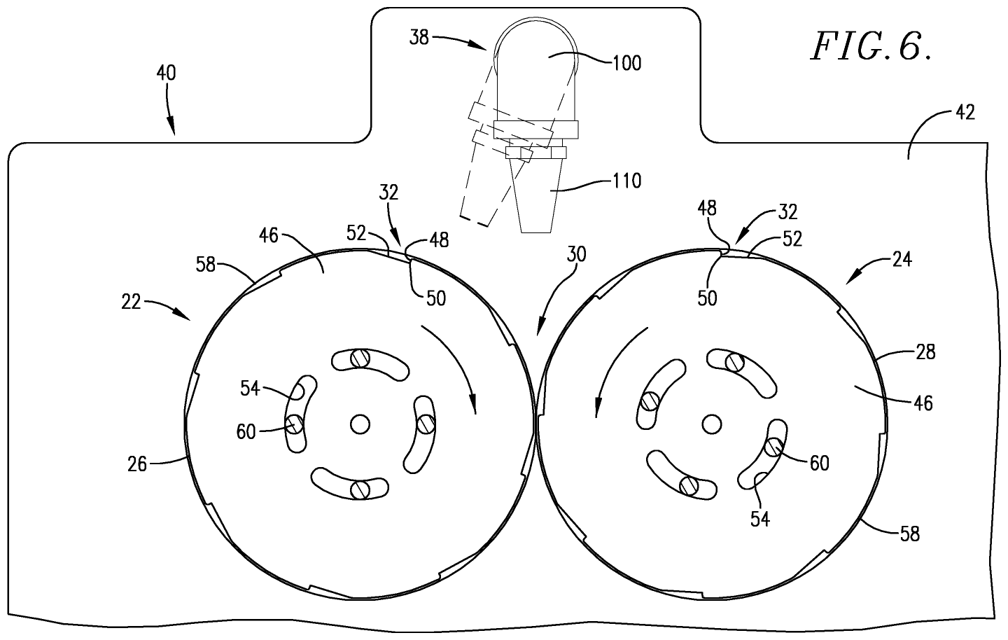

Also, while a simple elbow has been shown as the outlet 100, a restricted orifice nozzle 110 may be used in lieu thereof (see FIGS. 2, and 4-6). Any such outlet may also be rotated from a position directly above the nip region 30 to further alter the delivery pattern of the coating material (see FIG. 6).

I claim:

1. Coating apparatus comprising:
a pair of cylindrical, juxtaposed bodies each presenting a peripheral surface and oriented to cooperatively define a nip region between said peripheral surfaces,
each of said peripheral surfaces equipped with a series of laterally spaced apart notches;
apparatus for rotating said bodies in opposite rotational directions, respectively; and
structure for delivery of a coating liquid towards said juxtaposed bodies for passage through said nip region from one side of the bodies during rotation thereof, such that said coating liquid is ejected from the nip region after passage therethrough in a direction away from the bodies.

2. The apparatus of claim 1, said notches defining a chevron pattern with an apex and a pair of diverging legs extending from said apex, so that the apices of said chevron patterns are shifted toward and through the nip region, with the diverging legs of the chevron patterns trailing said apices.

3. The apparatus of claim 1, each of said bodies comprising a plurality of individual plates secured together in a face-to-face relationship to present the peripheral surfaces, each of said plates having a notch formed in the periphery thereof.

4. The apparatus of claim 3, each of said plates equipped with a plurality of arcuate adjustment slots therethrough, there being a series of connection bolts extending through the adjustment slots of each of the plates, so that the relative rotational positions of the individual plates may be adjusted.

5. The apparatus of claim 1, each of the peripheries of said bodies having a plurality of circumferentially spaced apart and laterally extending notches.

6. The apparatus of claim 5, said circumferentially spaced apart and laterally extending notches defining a corresponding plurality of said chevron patterns.

7. The apparatus of claim 1, said rotating apparatus comprising a motor operatively secured to said one of said bodies, the bodies being in frictional engagement so that the driven rotation of said one body effects counter-rotation of the other body.

8. The apparatus of claim 7, said rotating apparatus comprising a variable speed motor.

9. The apparatus of claim 7, each of said bodies having at least one driving plate, the two driving plates being in frictional engagement.

10. The apparatus of claim 9, including tensioning apparatus for adjusting the driving engagement between said driving plates.

11. The apparatus of claim 1, each of said notches having an inclined bottom surface.

12. The apparatus of claim 1, said coating liquid being ejected in a diverging pattern from said nip region.

13. The apparatus of claim 2, the included angle between said diverging legs being from about 20-70°.

14. The apparatus of claim 1, said delivery structure comprising an outlet pipe proximal to said bodies.

15. The apparatus of claim 14, said outlet pipe being rotationally adjustable.

16. The apparatus of claim 1, said rotating apparatus operable to rotate said bodies at a speed of from about 40-800 rpm.

17. The apparatus of claim 1, said delivery structure located above said bodies and nip region.

18. A method of applying a liquid coating material onto a substrate, comprising the steps of:
directing a stream of said liquid coating material generally towards said substrate, and passing the coating material into and through a nip region defined by a pair of cylindrical, juxtaposed bodies each presenting a peripheral surface;
rotating said cylindrical bodies in opposite rotational directions, respectively,
the peripheries of said cylindrical bodies equipped with a series of laterally extending notches; and
causing said bodies, and the notches in the peripheries thereof, to expel said liquid coating material from said nip region and onto said substrate.

19. The method of claim 18, said notches defining a chevron pattern with an apex and a pair of diverging legs extending from said apex, so that the apices of said chevron patterns are shifted toward and through the nip region, with the diverging legs of the chevron patterns trailing said apices.

20. The method of claim 19, the peripheries of said cylindrical bodies having a plurality of circumferentially spaced apart notches defining a corresponding plurality of said chevron patterns.

21. The method of claim 18, including the step of driving one of said bodies using a motor, and causing said driven body to frictionally engage and rotate the other of said bodies.

22. The method of claim 18, including the step of expelling said liquid coating material from said nip region in a diverging pattern.

23. The method of claim 18, including the step of directing said liquid coating material through an outlet pipe above said bodies, said substrate located below said bodies.
